(19) United States
(12) Patent Application Publication
(10) Pub. No.: US 2018/0020309 A1
(43) Pub. Date: Jan. 18, 2018

(54) Synchronized Audio Playback Devices

(71) Applicant: Bose Corporation, Framingham, MA (US)

(72) Inventors: Debasmit Banerjee, Framingham, MA (US); Michael Elliot, Grafton, MA (US)

(73) Assignee: Bose Corporation, Framingham, MA (US)

(21) Appl. No.: 15/212,246

(22) Filed: Jul. 17, 2016

(51) Int. Cl. H04S 7/00; H04R 5/04; G06F 3/16; H04R 27/00; G11B 20/10

(52) U.S. Cl. CPC H04S 7/30; H04R 27/00; G11B 20/10037; G11B 20/10222; G06F 3/165; H04R 5/04; H04R 2227/003; H04R 2227/005; H04R 2420/07

(57) ABSTRACT

A method for synchronizing audio playback by the audio playback devices of a group with at least two audio playback devices, where the group is part of a larger zone of audio playback devices, and where one audio playback device of the zone is a master audio playback device that distributes audio data to other audio playback devices of the zone. An audio play command is received from the master audio playback device at one audio playback device of the group and in response, an audio control command is transmitted from the one audio playback device of the group to at least one other audio playback device of the group.

### BACKGROUND

This disclosure relates to synchronization of the audio played by audio playback devices.

Groups of audio playback devices, such as left-right stereo pairs of devices, or multiple devices of a surround sound system, need to be synchronized such that the audio data is played by each device at the appropriate time.

### SUMMARY

All examples and features mentioned below can be combined in any technically possible way.

In one aspect, a method for synchronizing audio playback by the audio playback devices of a group comprising at least two audio playback devices, where the group is part of a larger zone of audio playback devices, and where one audio playback device of the zone is a master audio playback device that distributes audio data to other audio playback devices of the zone, includes receiving an audio play command from the master audio playback device at one audio playback device of the group and in response to receiving an audio play command from the master audio playback device at one audio playback device of the group, transmitting an audio control command from the one audio playback device of the group to at least one other audio playback device of the group.

Embodiments may include one of the following features, or any combination thereof. The group may include a stereo pair of audio playback devices. The group may include multiple surround sound audio playback devices. The audio control command may be a playback command. The playback command may include a play-at time when the at least one other audio playback device of the group is to begin playing audio data received from the master audio playback device. The method may further comprise the master audio playback device suspending group playback after playback has begun, upon detection by another audio playback device of an error. The method may further comprise recovering from the suspension by at least one of retrying playback and retrying clock synchronization and playback. The method may further comprise, if the group master determines that connectivity and communication is not possible to a group slave, suspending group playback.

Embodiments may include one of the following features, or any combination thereof. The audio control command may be transmitted from the one audio playback device of the group to each of the other audio playback devices of the group. The audio playback devices that are included with the group may be selected by a user from the audio playback devices of the zone. The audio playback devices can be wireless loudspeaker units.

In another aspect, an audio playback device includes a digital-to-analog converter configured to receive an audio stream comprising a digital representation of audio content via a network and convert the audio stream to analog form, an electro-acoustic transducer, a network interface, and a processor coupled to the digital-to-analog converter, the electro-acoustic transducer, and the network interface. The processor is configured to receive an audio play command from a master audio playback device and in response to receiving an audio play command from the master audio playback device, transmit an audio control command to at least one other audio playback device.

Embodiments may include one of the above and/or below features, or any combination thereof. The audio control command may be a playback command. The playback command may be a play-at time when the at least one other audio playback device is to begin playing audio data received from the master audio playback device. The audio control command may be transmitted to a plurality of other audio playback devices. The audio playback device may be a wireless loudspeaker unit.

In another aspect, an audio system includes a plurality of audio playback devices for providing synchronized playback of streamed audio, wherein each audio playback device of the plurality is configured to receive an audio play command from a master audio playback device and in response to receiving an audio play command from the master audio playback device, transmit an audio control command to at least one other audio playback device.

Embodiments may include one of the above and/or below features, or any combination thereof. The at least one other audio playback device may be one of a stereo pair of audio playback devices. The at least one other audio playback device may include multiple surround sound audio playback devices. The audio control command may be a playback command. The playback command may include a play-at time when the at least one other audio playback device is to begin playing audio data received from the master audio playback device. The audio control command may be transmitted to a plurality of other audio playback devices. The audio playback devices may be wireless loudspeaker units.

### BRIEF DESCRIPTION OF THE DRAWINGS

FIG. 1 is schematic block diagram of an audio distribution system.

FIG. 2 is a schematic block diagram of a mixed-mode audio distribution system.

FIG. 3 is a swim lane diagram illustrating steps of synchronizing audio play among several audio playback devices.

FIGS. 4A and 4B are perspective and top plan views, respectively, of an exemplary audio playback device of the audio systems of FIGS. 1 and 2.

FIG. 4C is a block diagram of the audio playback device of FIGS. 4A and 4B.

### DETAILED DESCRIPTION

A group of two or more audio playback devices, such as left-right stereo pairs of devices, or multiple devices of a surround sound system, can be synchronized such that the audio data is played by each device at the appropriate time by designating one device of the group as the group master device that controls the audio playback time of each device of the group.

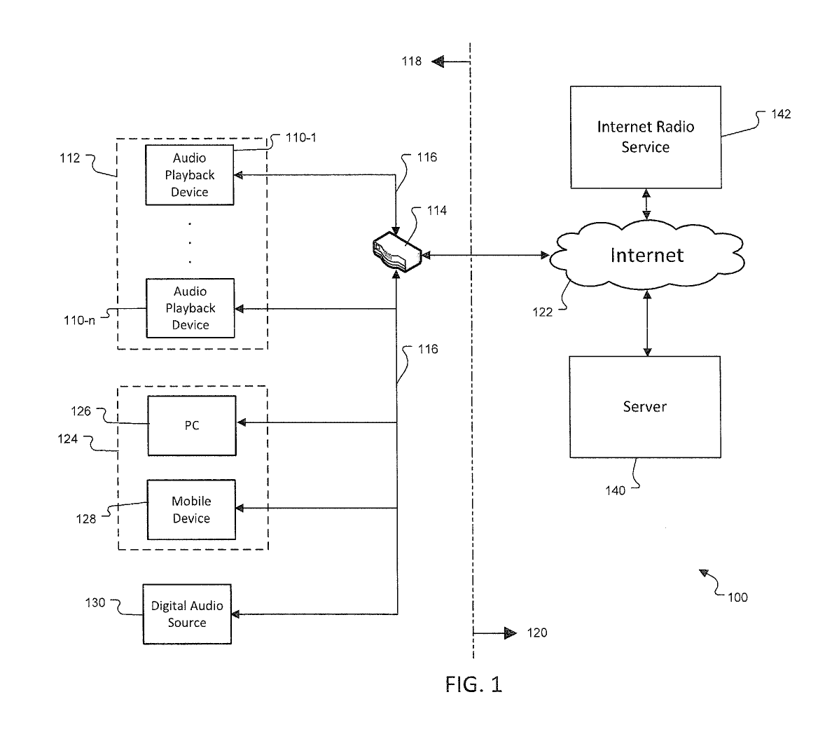

Audio distribution system 100, FIG. 1, can be used to accomplish a method for distributing audio data to, and synchronizing audio data among, a plurality of audio playback devices that are connected to a network. System 100 also includes the audio playback devices and the computer devices that are involved in the subject audio distribution. System 100 is adapted to deliver digital audio (e.g., digital music). System 100 includes a number of audio playback devices 110-1-110-n (collectively referenced as 110), which are among the zone of audio output devices 112 of the system. In one non-limiting embodiment, the audio playback devices are identical devices that each include a digital to analog converter that is able to receive digital audio signals and convert them to analog form. The audio playback devices also include an electro-acoustic transducer that receives the analog audio signals and transduces them into sound. The audio playback devices also include a processor. The audio playback devices are connected to one another and also connected to the router/access point 114 via network 116. The audio playback devices are thus able to communicate with one another. Network 116 can be a wired and/or wireless network, and can use known network connectivity methodologies. Network 116 is part of LAN 118 which is connected to wide area network (WAN) 120, in this non-limiting example by connection to Internet 122. LAN 118 also includes one or more separate computing devices 124 and one or more separate local digital audio sources 130. In this non-limiting example the computing devices include a personal computer 126 and a mobile computing device 128 such as a smart phone, tablet or the like. WAN 120 includes server 140 and Internet radio service 142 which can both communicate with the LAN via Internet 122.

One use of system 100 is to play digital audio data, including but not limited to an audio stream, over one or more of the audio playback devices in zone 112. The sources of digital audio provide access to content such as audio streams that move over network 116 to the audio playback devices. The sources of such audio streams can include, for example, Internet radio stations and user defined playlists. Each of such digital audio sources maintains a repository of audio content which can be chosen by the user to be played over one or more of the audio playback devices. Such digital audio sources can include Internet-based music services such as Pandora®, Spotify® and vTuner®, for example. Network attached storage devices such as digital audio source 130, and media server applications such as may be found on a mobile computing device, can also be sources of audio data. In a non-limiting example, the user selects the audio source and the playback devices via PC 126 and/or mobile device 128.

When a user has chosen to have an audio stream played on more than one of the audio playback devices, in order for the music to be properly synchronized such that the same tracks are playing synchronously on all of the audio playback devices there needs to be appropriate and sufficient coordination among all of the active audio playback devices. One manner in which such coordination can be accomplished is to use one of the audio playback devices to control the distribution of audio data to all of the other active audio playback devices that are being used to play content. This device which controls audio data distribution to the other active playback devices can be considered a master device, and the rest of the active devices (i.e., the rest of the playback devices that are being used to play content) can be considered to be slave devices. In addition to an audio stream, the master device also provides control data (e.g., via a control data stream) to at least some of the slave devices. The control data includes timing information which enables the slave devices to synchronize playback of the streamed audio content with the master device. In one example, the control data includes a “play at” time, which corresponds to a time when the playback devices are to begin playback of the streamed audio data. Devices joining the playback group after playback has started may also use the “play at” time to determine where in the stream to begin playback in order to sync up with the playback devices in the group.

To help ensure that the playback of the audio content is and remains synchronized, the respective internal clocks of the individual playback devices are synchronized. In principle, such clocks comprise an oscillator and a counter. Clock synchronization of audio playback devices is further described in application Ser. No. 15/087,021, filed on Mar. 31, 2016, the entire disclosure of which is incorporated herein by reference.

In an existing multi-device system, such as disclosed in U.S. Pat. No. 9,078,072, the disclosure of which is incorporated herein by reference, when one or more playback devices are added to an already playing playback device, the result is the formation of a multi-device zone which is managed by the playback device that was initially playing the audio. All of the playback devices are clock synchronized. The audio data that gets distributed to the playback devices are time-stamped, and due to clock synchronization the audio is played synchronously at all playback devices. The manager of the zone is the master device, and its main functions are audio control and audio distribution. The remaining device(s) in the zone are referred to as slaves. The device which is responsible for the clock synchronization is called the clock master. The clock master is part of the same network as all the other speakers, but may or may not be part of the same zone. In some cases the clock master can be the same as the master device, but it need not be.

The main roles of the audio master are audio distribution to and audio control of the slaves. The audio master establishes secure connections to each of the slaves in the zone. This connection may or may not be over the home router or access point, and the connection between each slave and the master may or may not be unique (i.e., the connection can be unicast or multicast). Time-stamped audio packets are then distributed over each of these connections to the individual slaves. The slaves use the time-stamps to play audio at the correct time. Apart from an audio distribution channel, there is also a control channel which is established between the audio master and the slave devices. The control channel is used to send out audio control messages. When playback is requested at the audio master, the audio master starts buffering the data before starting playback. During this time audio is also distributed to the slaves through the audio distribution channel.

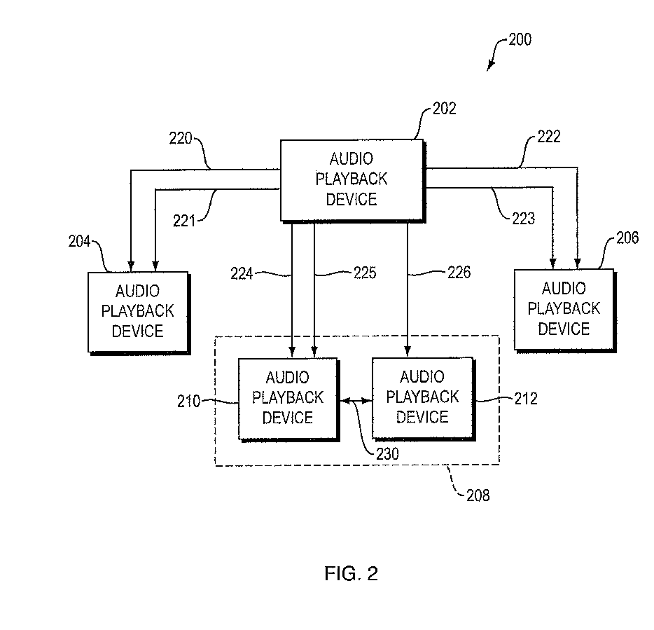

In the present case, two or more of the audio playback devices of the zone are configured as a coordinated group, for example for left-right stereo pair playback, or as multiple speakers of a surround sound system. The members of the group are preferably selected by the user, for example via a user interface (UI) of a Smartphone app that can be used to set-up the zone and group. Also, the group master is typically pre-established as either the left or right device of the group, or as a defined one device of the surround sound group of devices. In such cases, the devices of the group play different channels of the same audio stream, at least some of the time. An example is depicted as audio distribution system (zone) 200, FIG. 2, with audio playback devices 202, 204, 206, 210 and 212. In such a configuration mode, the roles of audio master and clock master still exist. However, there is an additional role of group master, which is performed by one of the devices of the group, and group slave(s), which is performed by the rest of the member devices of the group. In the present non-limiting example, device 210 is the group master of stereo pair group 208 that includes devices 210 and 212, one of which is the left speaker and the other of which is the right speaker.

Group master 210 is the audio control master of left-right group 208. Master device 210 can be either the left or the right device of group 208. The other device of the group (212) is the group slave to the group master, much in the same way all devices in a regular multi-device configuration are control slaves to the audio master. The main functionality of the group master is to decide when the devices of the group start playback. This decision is made when the group master receives a play command from the zone audio master and (i) all of the devices of the group have reached minimum required buffer depth to start playback, (ii) the device package hardware is ready on all group devices, and (iii) the clocks on all group devices are synced to the clock master. Both the devices in group 208 start playback simultaneously as soon as the group master 210 issues a command to do so based on these requirements. This is further described below.

There may also be situations in which playback needs to be suspended after it has begun, for example in error recovery situations such as when a slave detects one of the following errors: buffering underflow, decode/parsing failures, clock sync failure, or similar networking failures. If connectivity and communication is possible between the group slave(s) and the group master, the group master will immediately suspend playback by the group slave(s). Mechanisms to recover from any such suspension include retrying playback (buffering and control stream only; typically used only for suspensions due to stream corruption issues) and retrying clock synchronization and playback. If connectivity and communication is not possible to a group slave, the group master will detect loss of communication without feedback and suspend group playback.

The role of the zone audio master 202 is the same for this mixed-mode configuration (i.e., a configuration with a zone master and a group master) 200 as it is for the regular configuration disclosed in U.S. Pat. No. 9,078,072. In the case where one device of group 208 is the audio master (i.e., the controller of the zone), any device of the group can be the audio master.

In the mixed-mode setup illustrated by system 200, FIG. 2, the audio control between regular slaves 204 and 206 (i.e., the slaves that are not part of group 208) and the audio master remains unchanged. Control is accomplished over control channels 220 and 222. When the devices of group 208 are part of the zone of devices connected to the audio master, the master 210 of group 208 acts as a control slave to the zone audio master 202 (via control channel 224), and receives and processes all control commands. However, the group slave(s) (e.g., device 212) is a control slave to the group master 210 and only receives control commands from group master 210 (via control channel 230), as mentioned above. Thus, group slaves do not receive control commands from the zone master device.

Zone audio master 202 preferably distributes audio to all other devices of the zone, including all devices of the group 208, although audio distribution to the devices of the zone could be handled in other manners, such as from the source directly to each active device. Audio channels 221, 223, 225 and 226 are used for distribution of audio from zone master 202 to each other device. Also, preferably but not necessarily, all devices of group 208 receive all of the audio data that is to be played on all of the devices of the group. Thus both of devices 210 and 212 receive all of the left and right audio data (or in the case of a different group such as a surround sound group, each of the devices of the group receives all of the data for the entire group). This enables additional functionality, such as custom equalization and down-mix for the group, which govern how the audio will be played back on each of the devices.

The devices in a zone are typically positioned in separate locations (e.g., separate rooms) from each other, so a small delay between the beginning of playback on the devices is less likely to be noticeable. Furthermore, each of the devices of a zone typically provide the same audio content (e.g., they all provide L and R audio content of a stereo audio stream) so even when those devices are within earshot of each other a small delay in the start of playback between the devices will be less noticeable. However, in the situation in which a pair of devices are “grouped” to provide L-R stereo (i.e., one device providing only L channel content and the other group device providing only R channel content) a relative delay in the start of playback will be very noticeable because the devices are usually within close proximity to each other (e.g., at least in the same room), and each device only provides one channel of multichannel content, so the momentary absence of content during even a brief relative delay will be quite noticeable. Thus, controlling “grouped” devices in the manner described herein also helps to ensure that collectively the grouped devices behave as a single speaker—so one device of the pair doesn't start playing before the other.

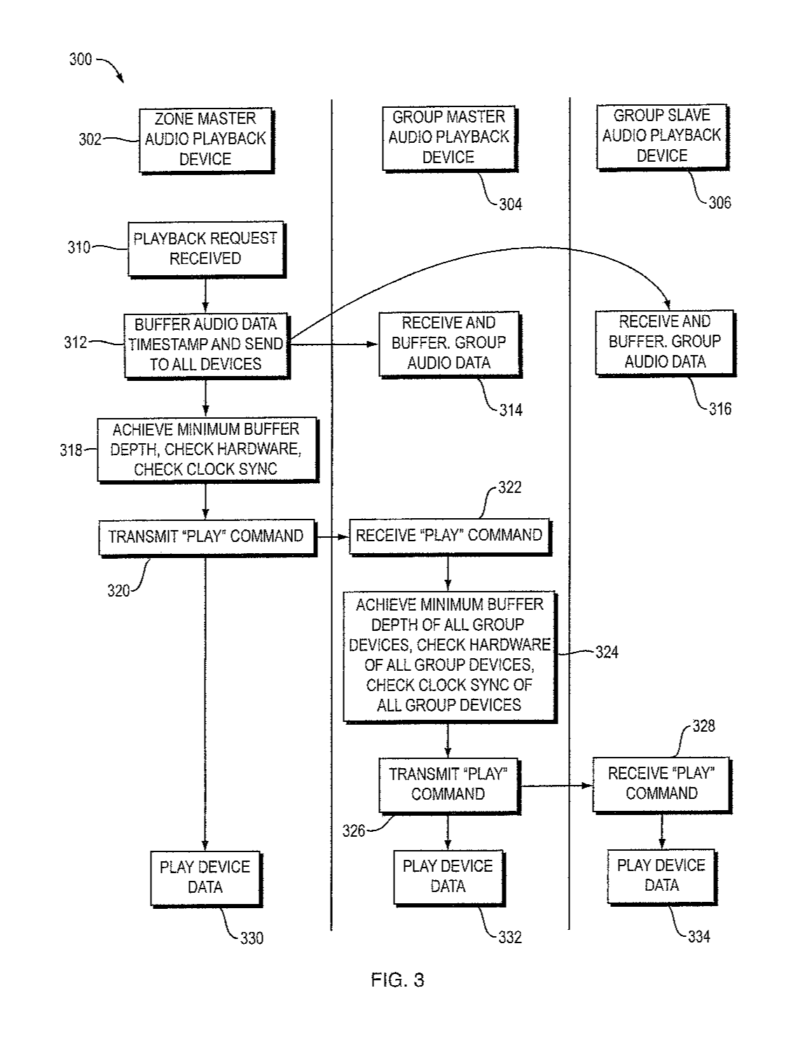

Referring to FIG. 3, three swim lanes are shown in swim-lane diagram 300, including lane 302 that relates to the master audio playback device of the zone of such devices (e.g., device 202, FIG. 2), lane 304 that relates to the group master audio playback device (e.g., device 210, FIG. 2), and lane 306 that relates to the group slave audio playback device(s) (e.g., device 212, FIG. 2). At step 310, the zone master device receives a playback request (e.g., a request to play an audio stream from a connected device or an Internet radio station). The zone master device then begins to buffer the requested audio data, time-stamp data packets and send the time-stamped packets to each of the zone slave devices, including but not limited to the devices of the group. The group master and group slave(s) each receive the same data, steps 314 and 316. This data includes the data to be played by each of the devices of the group (which in this non-limiting example includes left and right stereo channel data for the group).

At step 318, once the zone master device has achieved the minimum buffer depth required to start playback, it checks to see if its hardware is ready to play the data and if its clock is synchronized with the clock master. If so, it transmits a “play” command, step 320, to the group master; the play command is not sent to the group slave device(s). The group master receives the play command, step 322. The group master then checks (via the control channels) all devices of the group to determine whether they have achieved the minimum buffer depth required to start playback, whether the hardware of all the devices is ready to play the data, and whether the clocks of all the group devices are synchronized with the clock master. If so, the group master transmits a control command (e.g., a “play” command) to each group slave, step 326. The group slave(s) then receive the play command, step 328. All of the devices then begin to play data at the designated play-at time, as described elsewhere herein, steps 330, 332 and 334. When a group is added to a zone, the group master device should prevent the stream play-at time from being in the past, as this would cause the group master and group slave(s) to attempt to play immediately; this could cause the group master and group slave(s) to start play at different times due to network propagation delays and so should be avoided. In the case where the control command is something other than a “play” command, for example a “pause” or “stop” command, the group slave device(s) take the appropriate synchronized commanded action(s).

In a configuration in which there is a “group” but no separate “zone” of devices (e.g., where the active devices are the multiple devices of a surround sound system), the group master does not receive a command from a zone master device (as in step 322), because there is no zone master device. Rather, the group master originates the play command in step 322.

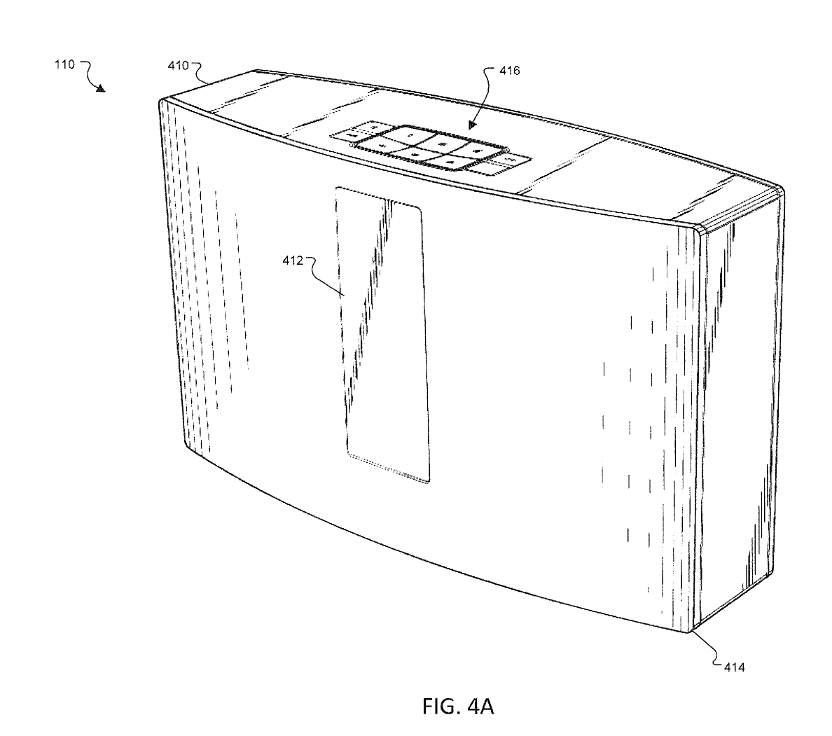

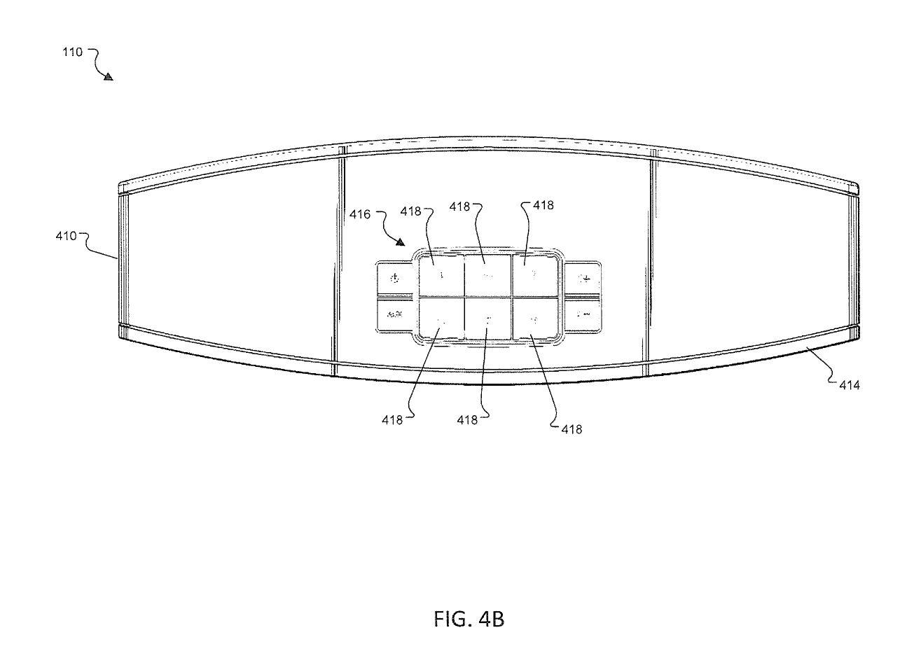

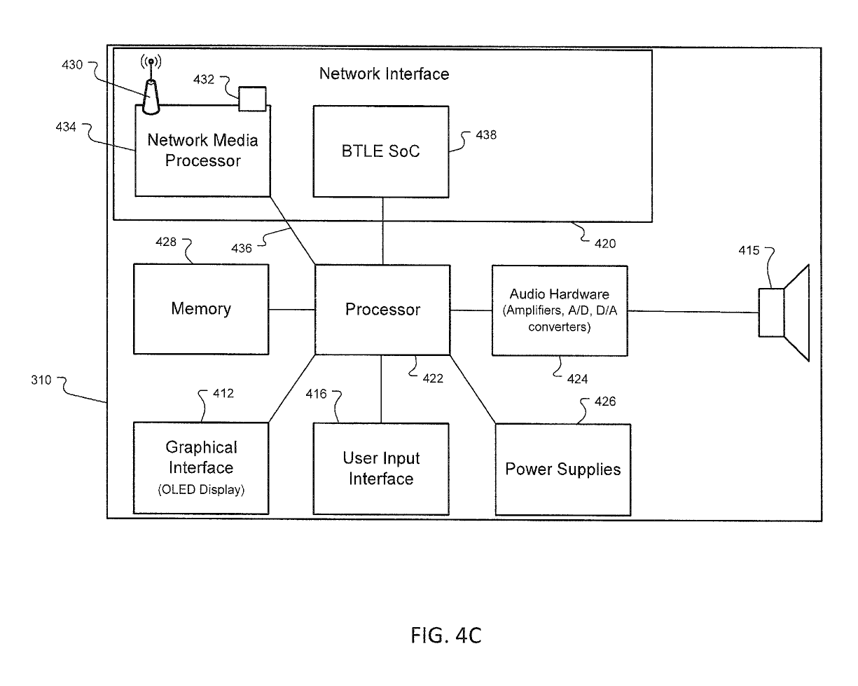

An exemplary audio playback device 110 will now be described in greater detail with reference to FIGS. 4A through 4C. Referring to FIG. 4A, an audio playback device 110 includes an enclosure 410 and on the enclosure 410 there resides a graphical interface 412 (e.g., an OLED display) which can provide the user with information regarding currently playing (“Now Playing”) music and information regarding the presets. A screen 414 conceals one or more electro-acoustic transducers 415 (FIG. 4C). The audio playback device 110 also includes a user input interface 416. As shown in FIG. 4B, the user input interface 416 includes a plurality of preset indicators 418, which are hardware buttons in the illustrated example. The preset indicators 418 (numbered 1-6) provide the user with easy, one press access to entities assigned to those buttons. That is, a single press of a selected one of the preset indicators 418 will initiate streaming and rendering of content from the assigned entity.

The assigned entities can be associated with different ones of the digital audio sources such that a single audio playback device 110 can provide for single press access to various different digital audio sources. In one example, the assigned entities include at least (i) user-defined playlists of digital music and (ii) Internet radio stations. In another example, the digital audio sources include a plurality of Internet radio sites, and the assigned entities include individual radio stations provided by those Internet radio sites.

Notably, the preset indicators 418 operate in the same manner, at least from a user's perspective, regardless of which entities are assigned and which of the digital audio sources provide the assigned entities. That is, each preset indicator 418 can provide for single press access to its assigned entity whether that entity is a user-defined playlist of digital music provided by an NAS device or an Internet radio station provided by an Internet music service.

With reference to FIG. 4C, the audio playback device 110 also includes a network interface 420, a processor 422, audio hardware 424, power supplies 426 for powering the various audio playback device components, and memory 428. Each of the processor 422, the graphical interface 412, the network interface 420, the processor 422, the audio hardware 424, the power supplies 426, and the memory 428 are interconnected using various buses, and several of the components may be mounted on a common motherboard or in other manners as appropriate.

The network interface 420 provides for communication between the audio playback device 110, the remote server (item 140, FIG. 1), the audio sources and other audio playback devices 110 via one or more communications protocols. The network interface 420 may provide either or both of a wireless interface 430 and a wired interface 432. The wireless interface 430 allows the audio playback device 110 to communicate wirelessly with other devices in accordance with a communication protocol such as such as IEEE 802.11 b/g. The wired interface 432 provides network interface functions via a wired (e.g., Ethernet) connection.

In some cases, the network interface 420 may also include a network media processor 434 for supporting Apple AirPlay® (a proprietary protocol stack/suite developed by Apple Inc., with headquarters in Cupertino, Calif., that allows wireless streaming of audio, video, and photos, together with related metadata between devices). For example, if a user connects an AirPlay® enabled device, such as an iPhone or iPad device, to the LAN 118, the user can then stream music to the network connected audio playback devices 110 via Apple AirPlay®. A suitable network media processor is the DM870 processor available from SMSC of Hauppauge, N.Y. The network media processor 434 provides network access (i.e., the Wi-Fi network and/or Ethernet connection can be provided through the network media processor 434) and AirPlay® audio. AirPlay® audio signals are passed to the processor 422, using the 12S protocol (an electrical serial bus interface standard used for connecting digital audio devices), for downstream processing and playback. Notably, the audio playback device 110 can support audio-streaming via AirPlay® and/or DLNA's UPnP protocols, and all integrated within one device.

All other digital audio coming from network packets comes straight from the network media processor 434 through a USB bridge 436 to the processor 422 and runs into the decoders, DSP, and eventually is played back (rendered) via the electro-acoustic transducer(s) 415.

The network interface 420 can also include a Bluetooth low energy (BTLE) system-on-chip (SoC) 438 for Bluetooth low energy applications (e.g., for wireless communication with a Bluetooth enabled controller (not shown)). A suitable BTLE SoC is the CC2540 available from Texas Instruments, with headquarters in Dallas, Tex.

Streamed data pass from the network interface 420 to the processor 422. The processor 422 can execute instructions within the audio playback device (e.g., for performing, among other things, digital signal processing, decoding, and equalization functions), including instructions stored in the memory 428. The processor 422 may be implemented as a chipset of chips that include separate and multiple analog and digital processors. The processor 422 may provide, for example, for coordination of other components of the audio playback device 110, such as control of user interfaces, applications run by the audio playback device 110. A suitable processor is the DA921 available from Texas Instruments.

The processor 422 provides a processed digital audio signal to the audio hardware 424 which includes one or more digital-to-analog (D/A) converters for converting the digital audio signal to an analog audio signal. The audio hardware 424 also includes one or more amplifiers which provide amplified analog audio signals to the electroacoustic transducer(s) 415 for playback. In addition, the audio hardware 424 may include circuitry for processing analog input signals to provide digital audio signals for sharing with other devices in the acoustic system 100.

The memory 428 may include, for example, flash memory and/or non-volatile random access memory (NVRAM). In some implementations, instructions (e.g., software) are stored in memory 428. The instructions, when executed by one or more processing devices (e.g., the processor 422), perform one or more processes, such as those described above (e.g., with respect to FIG. 3). The instructions can also be stored by one or more storage devices, such as one or more computer- or machine-readable mediums (for example, the memory 428, or memory on the processor). The instructions may include instructions for performing decoding (i.e., the software modules include the audio codecs for decoding the digital audio streams), as well as digital signal processing and equalization.

Elements of figures are shown and described as discrete elements in a block diagram. These may be implemented as one or more of analog circuitry or digital circuitry. Alternatively, or additionally, they may be implemented with one or more microprocessors executing software instructions. The software instructions can include digital signal processing instructions. Operations may be performed by analog circuitry or by a microprocessor executing software that performs the equivalent of the analog operation. Signal lines may be implemented as discrete analog or digital signal lines, as a discrete digital signal line with appropriate signal processing that is able to process separate signals, and/or as elements of a wireless communication system.

When processes are represented or implied in the block diagram, the steps may be performed by one element or a plurality of elements. The steps may be performed together or at different times. The elements that perform the activities may be physically the same or proximate one another, or may be physically separate. One element may perform the actions of more than one block. Audio signals may be encoded or not, and may be transmitted in either digital or analog form. Conventional audio signal processing equipment and operations are in some cases omitted from the drawing.

Embodiments of the systems and methods described above comprise computer components and computer-implemented steps that will be apparent to those skilled in the art. For example, it should be understood by one of skill in the art that the computer-implemented steps may be stored as computer-executable instructions on a computer-readable medium such as, for example, floppy disks, hard disks, optical disks, Flash ROMS, nonvolatile ROM, and RAM. Furthermore, it should be understood by one of skill in the art that the computer-executable instructions may be executed on a variety of processors such as, for example, microprocessors, digital signal processors, gate arrays, etc. For ease of exposition, not every step or element of the systems and methods described above is described herein as part of a computer system, but those skilled in the art will recognize that each step or element may have a corresponding computer system or software component. Such computer system and/or software components are therefore enabled by describing their corresponding steps or elements (that is, their functionality), and are within the scope of the disclosure.

A number of implementations have been described. Nevertheless, it will be understood that additional modifications may be made without departing from the scope of the inventive concepts described herein, and, accordingly, other implementations are within the scope of the following claims.

For example, the concepts described above work not only with dedicated speaker packages, such as illustrated in FIGS. 4A-4C, but also with computers, mobile devices, and other portable computing devices that can receive digital audio data and transduce it into sound.

What is claimed is:

1. A method for synchronizing audio playback by the audio playback devices of a group comprising at least two audio playback devices, where the group is part of a larger zone of audio playback devices, and where one audio playback device of the zone is a master audio playback device that distributes audio data to other audio playback devices of the zone, the method comprising:
receiving an audio play command from the master audio playback device at one audio playback device of the group; and
in response to receiving an audio play command from the master audio playback device at one audio playback device of the group, transmitting an audio control command from the one audio playback device of the group to at least one other audio playback device of the group.

2. The method of claim 1, wherein the group comprises a stereo pair of audio playback devices.

3. The method of claim 1, wherein the group comprises multiple surround sound audio playback devices.

4. The method of claim 1, wherein the audio control command comprises a playback command.

5. The method of claim 4, wherein the playback command comprises a play-at time when the at least one other audio playback device of the group is to begin playing audio data received from the master audio playback device.

6. The method of claim 5, further comprising the master audio playback device suspending group playback after playback has begun, upon detection by another audio playback device of an error.

7. The method of claim 6, further comprising recovering from the suspension by at least one of retrying playback and retrying clock synchronization and playback.

8. The method of claim 1, further comprising, if the group master determines that connectivity and communication is not possible to a group slave, suspending group playback.

9. The method of claim 1, wherein the audio control command is transmitted from the one audio playback device of the group to each of the other audio playback devices of the group.

10. The method of claim 1, wherein the audio playback devices that comprise the group are selected by a user from the audio playback devices of the zone.

11. The method of claim 1, wherein the audio playback devices comprise wireless loudspeaker units.

12. An audio playback device, comprising:
a digital-to-analog converter configured to receive an audio stream comprising a digital representation of audio content via a network and convert the audio stream to analog form;
an electro-acoustic transducer;
a network interface; and
a processor coupled to the digital-to-analog converter, the electro-acoustic transducer, and the network interface, the processor configured to:
receive an audio play command from a master audio playback device; and
in response to receiving an audio play command from the master audio playback device, transmit an audio control command to at least one other audio playback device.

13. The audio playback device of claim 12, wherein the audio control command comprises a playback command.

14. The audio playback device of claim 13, wherein the playback command comprises a play-at time when the at least one other audio playback device is to begin playing audio data received from the master audio playback device.

15. The audio playback device of claim 12, wherein the audio control command is transmitted to a plurality of other audio playback devices.

16. The audio playback device of claim 12, wherein the audio playback device comprises a wireless loudspeaker unit.

17. An audio system comprising:
a plurality of audio playback devices for providing synchronized playback of streamed audio, wherein each audio playback device of the plurality is configured to:
receive an audio play command from a master audio playback device; and
in response to receiving an audio play command from the master audio playback device, transmit an audio control command to at least one other audio playback device.

18. The audio system of claim 17, wherein the at least one other audio playback device comprises one of a stereo pair of audio playback devices.

19. The audio system of claim 17, wherein the at least one other audio playback device comprises multiple surround sound audio playback devices.

20. The audio system of claim 17, wherein the audio control command comprises a playback command.

21. The audio system of claim 20, wherein the playback command comprises a play-at time when the at least one other audio playback device is to begin playing audio data received from the master audio playback device.

22. The audio system of claim 17, wherein the audio control command is transmitted to a plurality of other audio playback devices.

23. The audio system of claim 17, wherein the audio playback devices comprise wireless loudspeaker units.
